(19) United States
(12) Patent Application Publication
(10) Pub. No.: US 2024/0386033 A1
(43) Pub. Date: Nov. 21, 2024

(54) WORKLOAD-BASED CLASSIFICATION OF SERVICES

(71) Applicant: INTERNATIONAL BUSINESS MACHINES CORPORATION, Armonk, NY (US)

(72) Inventors: James Donald THORNE, Porters Lake (CA); Brad NICHOLSON, Toronto (CA); Andrew SCHWARTZ, AMAGASAKI-SHI (JP); Thomas LUMPP, Pliezhausen (DE); Daniel PITTNER, Esslingen am Neckar (DE)

(21) Appl. No.: 18/318,073

(22) Filed: May 16, 2023

(51) Int. Cl. G06F 16/28

(52) U.S. Cl. CPC G06F 16/285

(57) ABSTRACT

A method, system, and computer program product that is configured to: collect a plurality of metrics for running service instances within a cloud-based system; classify the running service instances into a database classification using a machine learning algorithm based on the collected plurality of metrics for the running service instances; and perform at least one operational decision corresponding to the classified running service instances.

### BACKGROUND

Aspects of the present invention relate generally to a workload-based classification of services and, more particularly, to a workload-based classification of managed cloud services for risk minimization.

In a cloud computing environment, databases and other applications carry out query operations, which can run for a long time. Further, databases are usually located on a same machine to enhance efficiency. In order to guarantee high availability, each database has at least one fail-over instance on a different machine. Therefore, in aggregate, a service hosts many thousands of database instances across disparate geographies with varying workload patterns.

### SUMMARY

In a first aspect of the invention, there is a computer-implemented method including: collecting, by a processor set, a plurality of metrics for running service instances within a cloud-based system; classifying, by the processor set, the running service instances into a database classification using a machine learning algorithm based on the collected plurality of metrics for the running service instances; and performing, by the processor set, at least one operational decision corresponding to the classified running service instances.

In another aspect of the invention, there is a computer program product including one or more computer readable storage media having program instructions collectively stored on the one or more computer readable storage media. The program instructions are executable to: collect a plurality of metrics for running service instances within a system; classify the running service instances into a color classification using a machine learning algorithm based on the collected plurality of metrics for the running service instances; and deploy a change across the system via a phased rollout based on a classification of the running service instances.

In another aspect of the invention, there is a system including a processor set, one or more computer readable storage media, and program instructions collectively stored on the one or more computer readable storage media. The program instructions are executable to: collect a plurality of metrics for running service instances within a cloud-based system; classify the running service instances into a database classification using a k-means clustering algorithm based on the collected plurality of metrics for the running service instances; and perform at least one operational decision corresponding to the classified running service instances.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of a workload-based classification server in accordance with aspects of the present invention.

FIG. 3 shows a flowchart of an exemplary method of the workload-based classification server in accordance with aspects of the present invention.

### DETAILED DESCRIPTION

Aspects of the present invention relate generally to a workload-based classification of services and, more particularly, to a workload-based classification of managed cloud services for risk minimization. Embodiments of the present invention enable cloud services to increase stability and availability of a service by improving scheduling workloads and validating real-time changes as they are made in comparison to conventional database operations for services. Embodiments of the present invention enable cloud services to improve operational response time by providing additional data to on-call operators in comparison to conventional database operations for services. Embodiments of the present invention enable cloud services to increase customer satisfaction in comparison to conventional database operations for services. Embodiments of the present invention enable cloud services to improve both process and workload performance in comparison to conventional database operations for services. Embodiments of the present invention enable cloud services to decrease risk when rolling out changes to large fleets of database and/or service instances in comparison to conventional database operations for services. Embodiments of the present invention determine a workload pattern of each database service instance and perform operational decisions and/or actions based on the workload pattern of each database service instance. Embodiments of the present invention perform various operational decisions and/or actions, such as performing load balancing or security updates.

Embodiments of the present invention provide for risk minimization by increasing stability and availability of a cloud service by improving scheduling workloads and validating real-time changes as they occur across shared multi-tenant hosts, non-shared multi-tenant hosts, dedicated hosts, etc. Embodiments of the present invention also provide for improved operational response times by providing additional data to operators and/or automated services. Conventional systems are not able to dynamically schedule operational decisions based upon service workloads. Further, conventional systems are not able to minimize operational risk and maximize service uptime when implementing operational decisions because the operational decisions in conventional systems do not account for operation and performance metrics such as network utilization, disk size, disk utilization, memory utilization, central processing unit (CPU) usage, network connection count, etc. For example, conventional systems have differing use cases and workload patterns across thousands of highly-available stateful services on shared multitenant hosts that introduce operational and stability risk when software is updated, resources are allocated, and incidents are triaged.

Embodiments of the present invention provide for risk minimization by increasing stability and availability of a cloud service and improved operational response times. Accordingly, implementations of aspects of the present invention provide an improvement (i.e., technical solution) to a problem arising in the technical field of managing cloud services. In particular, embodiments of the present invention include collecting metrics for each service instance, automatically categorizing each service instance based on the collected metrics, and performing operational decisions based on the categorized service instance to minimize operational risk and maximize service uptime. Also, embodiments of the present invention may not be performed mentally and/or may not be performed in a human mind because aspects of the present invention comprise automatically categorizing each service instance using machine learning algorithms, such as k-means clustering, neural networks, dbscan, spectral clustering, etc.

Aspects of the present invention include a method, system, and computer program product for risk minimization of cloud-based services using a workload-based classification. For example, a computer-implemented method includes: collecting metrics including network utilization, disk size and utilization, memory utilization, processor usage, and network connection counts as time series data associated with each running service instance; classifying running service instances using collected metrics with predetermined unsupervised algorithms, including k-means clustering and network networks, to discover different workload segments; and applying classifications to the different workload segments to determine operational decisions capable of minimizing operation risk and maximize service uptime.

Implementations of aspects of the present invention are necessarily rooted in computer technology. For example, the step of classifying running service instances using collected metrics with unsupervised machine learning algorithms including k-means clustering and neural networks to discover different workload segments is computer-based and cannot be performed in the human mind. Using a machine learning model is, by definition, performed by a computer and cannot practically be performed in the human mind (or with pen and paper) due to the complexity and massive amounts of calculations involved. For example, an artificial neural network may have millions or even billions of weights the represent connections between nodes in different layers of the model. Values of these weights are adjusted, e.g., via backpropagation or stochastic gradient descent, when training the model is utilized in calculations when using the trained model to generate an output in real time (or near real time). Given this scale and complexity, it is simply not possible for the human mind, or for a person using pen and paper, to perform the number of calculations involved in using a machine learning model.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as workload-based classification code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

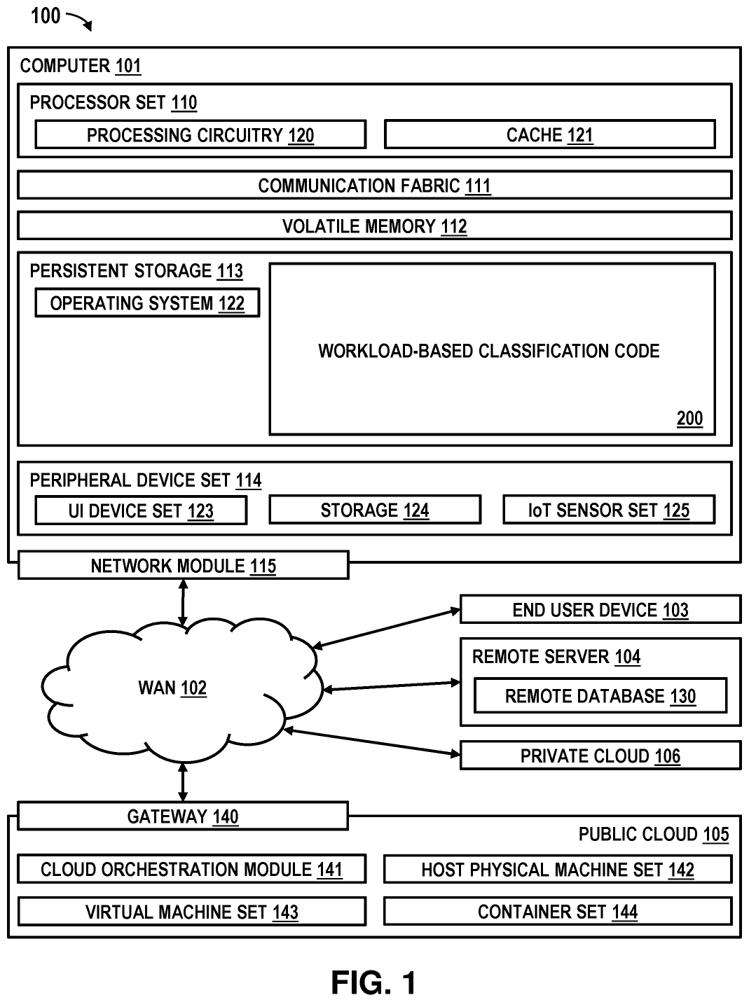

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

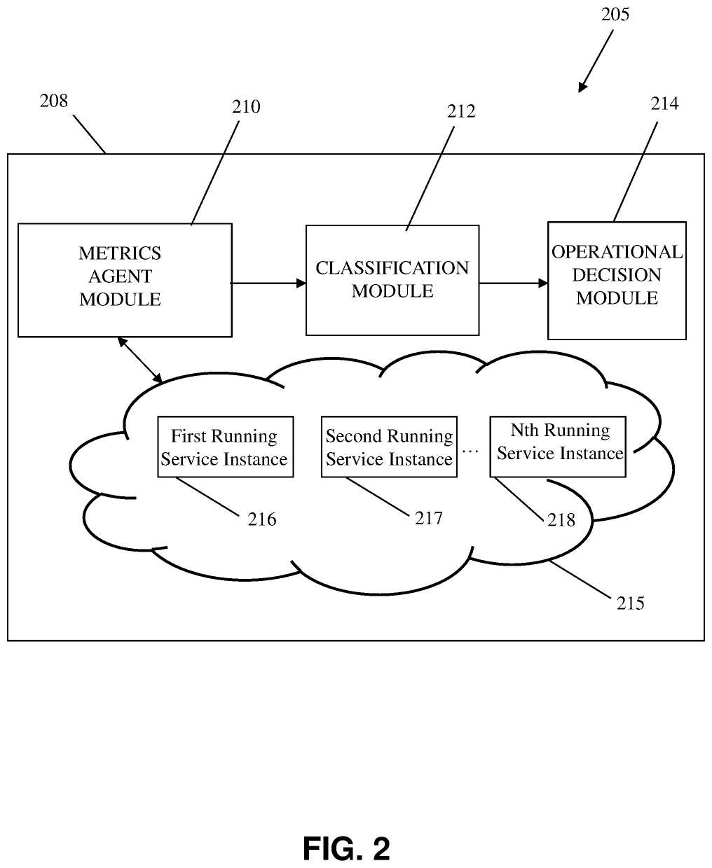

FIG. 2 shows a block diagram of an exemplary environment 205 in accordance with aspects of the invention. In embodiments, the environment 205 includes a workload-based classification server 208, which may comprise one or more instances of the computer 101 of FIG. 1. In other examples, the workload-based classification server 208 comprises one or more virtual machines or one or more containers running on one or more instances of the computer 101 of FIG. 1.

In embodiments, the workload-based classification server 208 of FIG. 2 comprises a metrics agent module 210, a classification module 212, and an operational decision module 214, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The workload-based classification server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the invention, the metrics agent module 210 collects metrics within a cloud-based system for each running service instance (e.g., database service instance). In embodiments of FIG. 2, the metrics agent module 210 collects metrics for a plurality of running service instances (e.g., a first running service instance 216, a second running service instance 217, . . . , a nth service instance 218) within a cloud-based system 215. In other embodiments, the metrics agent module 210 may be included in a database service instance within the cloud-based system 215. In embodiments, the metrics agent module 210 may be external to the database service instance and directly communicates with the database service instance within the cloud-based system 215. Further, in embodiments, the metrics agent module 210 collects various operational and performance metrics including at least one of network utilization, disk size, disk utilization, memory utilization, central processing unit (CPU) usage, network connection count, etc. from each running service instance of the plurality of running service instances (e.g., a first running service instance 216, a second running service instance 217, . . . , a nth service instance 218) within the cloud-based system 215. In particular, the metrics agent module 210 collects the operational and performance metrics as time-series data. In embodiments, the metrics agent module 210 sends the time-series data to a classification module 212.

In accordance with aspects of the invention, the classification module 212 automatically classifies each running service instance in the cloud-based system into a category using an unsupervised machine learning algorithm. In embodiments, the unsupervised machine learning algorithm may be at least one of a k-means clustering algorithm, a dbscan algorithm, a spectral clustering algorithm, etc. In embodiments, the classification module 212 selects the unsupervised machine learning algorithm to provide information on how the clusters were determined, which allows an operational team to make informed decisions when performing targeted or corrective actions against service instances and enables more focused recovery procedures. However, embodiments are not limited to these algorithms, and other unsupervised machine learning algorithms may be used by the classification module 212.

In embodiments, the k-means clustering algorithm is an algorithm of vector quantization that aims to partition n observations into k clusters in which each observation belongs to the cluster with the nearest mean (i.e., cluster center or cluster centroid) serving as a prototype of the cluster. Potential values for k in the k-means clustering may be found by an elbow algorithm. In embodiments, the elbow algorithm consists of plotting a variation as a function of a number of k clusters and picking an elbow of a curve plot as the number of k clusters to use. Accordingly, the k-means clustering algorithm will partition n observations based on the number of k clusters determined in the elbow algorithm. In embodiments, the classification module 212 automatically classifies each running service instance in the cloud-based system into a category using the k-means clustering algorithm.

In embodiments, the dbscan algorithm is an algorithm that finds density-connected clusters based on & (epsilon) neighborhood and a minimum number of points required to form a dense region (minimum points). In particular, the dbscan algorithm finds arbitrarily-shaped clusters and also finds a cluster completely surrounded by a different cluster (with no connections between the clusters). Further, the dbscan algorithm reduces a single-link effect (i.e., different clusters being connected by a thin line of points) due to the minimum number of points required to form the dense region. In embodiments, the dbscan algorithm performs filtering of outlier data which is regarded as noise. Accordingly, the dbscan algorithm is sensitive to noisy outlier data. Further, the dbscan algorithm requires only two parameters as inputs (i.e., epsilon and minimum points) and is not usually sensitive to the ordering of points in the database. The dbscan algorithm may only be sensitive to points sitting on the edge of two different clusters in response to the operating of the points being changed. Thus, the dbscan algorithm may be sensitive to swapping of cluster membership in response to the ordering of the points being changed. In embodiments, the classification module 212 automatically classifies each running service instance in the cloud-based system into a category using the dbscan algorithm.

In embodiments, the spectral clustering algorithm is an algorithm that makes use of a spectrum (i.e., eigenvalues) of a similarity matrix of data to perform dimensionality reduction before clustering in fewer dimensions. In particular, the similarity matrix is provided as an input and consists of a quantitative assessment of a relative similarity of each pair of points in a dataset. In embodiments, the spectral clustering algorithm shares an objective function with k-means clustering based on the weighted k clusters. In particular, the spectral clustering algorithm optimizes the objective function by multi-level methods. Further, the spectral clustering algorithm is related to a spectral version of the dbscan algorithm that finds density-connected components in a scenario with optimal clusters and no cut edges. In embodiments, the classification module 212 automatically classifies each running service instance in the cloud-based system into a category using the spectral clustering algorithm.

In embodiments, the classification module 212 automatically classifies each running service instance into a database classification or a color corresponding to the database classification (i.e., yellow classification, red classification, blue classification, etc.) using the unsupervised machine learning algorithm. For example, a database classification is based on load-related metrics such as an overall workload (e.g., a mixture of high central processing unit (CPU), high memory, and high input/output operations per seconds (IOPS) usage), an IOPS centric load, or a mixture of different load-related metrics. In another example, the database classification is based on at least one of a database usage of CPU, random access memory (RAM), disk, a database size, connectivity (e.g., a number of active connections), duration of transactions (e.g., many short transactions or a small number of long-running transactions), a time of day (e.g., increased usage overnight, decreased usage overnight, weekend usage, steady usage throughout the week, etc.), a growth rate (e.g., a fixed-size dataset vs growing over time), disk read rate (e.g., disk read-only, disk read-heavy workload, etc.), disk write rate (e.g., disk write-heavy workload). However, embodiments are not limited to these example, and the database classification and color classification may be based on different metrics.

In embodiments, after the classification module 212 automatically classifies each running service instance using the unsupervised machine learning algorithm, the classification module 212 sends each classified running service instance to the operational decision module 214. The operational decision module 214 performs at least one operational decision corresponding to the classified running service instance. For example, the operational decision module 214 deploys a change across a cloud-based system via a phased rollout. In particular, the operational decision module 214 samples categories of the classified running service instances to ensure that a representative subset of service instance workloads is selected in an initial rollout phase to detect issues with the deployed change across the cloud-based system as soon as possible. The operational decision module 214 minimizes the operational risk and service downtime by deploying the change in a selected representative subset of service instance workloads in the initial rollout phase. For example, the operational decision module 214 utilizes workload segmentation of online analytical processing (OLAP) and online transaction processing (OLTP) service instances (i.e., classification of service instances) based on the unsupervised machine learning algorithm to have a phased rollout process to ensure that both OLAP and OLTP workload service instances are tested in an initial phase before changes are released more broadly in the cloud-based system. In embodiments, in response to the operational decision module 214 determining that there are no detected issues with the deployed change in the selected representative subset of service instance workloads, the operational decision module 214 deploys the change across all remaining service instance workloads with a minimized operational risk and service downtime. In embodiments, in response to the operational decision module 214 determining that there are detected issues with the deployed change in the selected representative subset of service instance workloads, an operational team may find it easier to diagnose, debug, and fix the selected representative subset of service instance workloads as compared to the entire service instance workloads in the cloud-based system. For example, if the operational decision module 214 applies the deployed change to the selected representative subset of service instance workloads related to a high network connection count, the operational team may look more closely at the relationship between the high network connection count and the deployed change. In other embodiments, an automated debug module (not shown) diagnoses and debugs the selected representative subset of service instance workloads to find a root cause of the detected issues.

In another example, the operational decision module 214 triages operational alerts, adjusts alert thresholds to accurately reflect the state of each running service instance, and applies targeted actions the cloud-based system during customer-impacting events based on the classified running service instances. In particular, the operational decision module 214 triages operational alerts by sending alerts which include the classification of each running service instance to an operational team. In another example, the operational decision module 214 adjusts alert thresholds to alert the operational team in response to the classification of a running service instance changing based on a deterioration in operational and performance metrics of the running service instance. Accordingly, the operational decision module 214 is able to effectively handle operational issues with running service instances to minimize downtime.

In another example, the operational decision module 214 applies targeted actions to running service instances in response to the classified running service instances. In an example, the operational decision module 214 adjusts tuning parameters for only a predetermined class of workload service instances. In particular, the operational decision module 214 increases an input/output buffer size or increases transaction times in response to storage of a running service instance being degraded. Further, the operational decision module 214 triggers a re-synchronization of all replicas of predetermined classes of databases in response to a network outage. In particular, the operational decision module 214 triggers a re-synchronization of only write-heavy databases, which are less likely to recover from a network outage than read-heavy databases. The operational decision module 214 provides additional temporary resources to predetermined classes of databases in response to the cloud-based system being degraded or resources of the cloud-based system being contested. In particular, the operational decision module 214 provides additional memory to database service instances that would benefit from caching. The operational decision module 214 applies quality-of-service (QOS) policies to prioritize predetermined database classes that would benefit from the QoS policies. In particular, the operational decision module 214 prioritizes network transfer for latency-sensitive (i.e., short transactions) workload service instances over non latency-sensitive (i.e., long running transactions) workload service instances. However, embodiments are not limited, and the operational decision module 214 applies other targeted actions to running services instances in response to the classified running service instances.

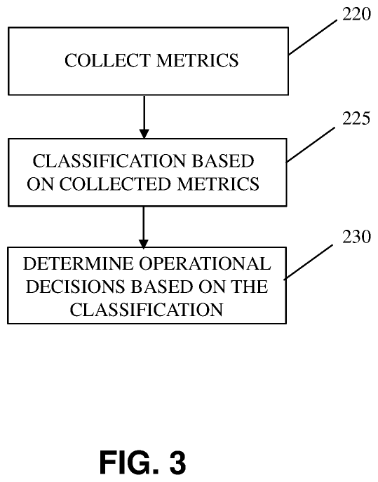

FIG. 3 shows a flowchart of an exemplary method of the workload-based classification server in accordance with aspects of the present invention. Steps of the method may be carried out in the environment of FIG. 2 and are described with reference to elements depicted in FIG. 2.

At step 220, the system collects, at the metrics agent module 210, metrics for each running service instance as time-series data. In embodiments, and as described with respect to FIG. 2, the metrics agent module 210 collects various operational and performance metrics including network utilization, disk size, disk utilization, memory utilization, CPU usage, network connection count, etc.

At step 225, the system automatically classifies, at the classification module 212, each running service instance into a category using an unsupervised machine learning algorithm. In embodiments, and as described with respect to FIG. 2, the classification module 212 selects the unsupervised machine learning algorithm to provide information on how the clusters were determined, which allows an operational team to make informed decisions when performing targeted or corrective actions against service instances and enables more focused recovery procedures.

At step 230, the system performs, at the operational decision module 214, at least one operational decision corresponding to the classified running service instance. In embodiments, and as described with respect to FIG. 2, the operational decision module 214 performs at least one operational decision, such as deploying a change across a cloud-based system via a phased rollout, triaging operational alerts, adjusting alert thresholds to accurately reflect the state of each running service instance, and applying targeted actions across the cloud-based system during customer-impacting events based on the classified running service instances.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
collecting, by a processor set, a plurality of metrics for running service instances within a cloud-based system;
classifying, by the processor set, the running service instances into a database classification using a machine learning algorithm based on the collected plurality of metrics for the running service instances; and
performing, by the processor set, at least one operational decision corresponding to the classified running service instances.

2. The method of claim 1, wherein the plurality of metrics is selected from the group consisting of network utilization, memory utilization, CPU usage, and network connection count.

3. The method of claim 1, wherein the machine learning algorithm comprises a k-means clustering algorithm.

4. The method of claim 1, wherein the machine learning algorithm comprises a dbscan algorithm.

5. The method of claim 1, wherein the running service instances within the cloud-based system comprise a database service instance.

6. The method of claim 1, wherein performing the at least one operational decision comprises deploying a change across the cloud-based system via a phased rollout based on a classification of the running service instances.

7. The method of claim 6, wherein deploying the change across the cloud-based system via the phased rollout comprises deploying the change across a representative subset of the running service instances in an initial rollout phase to detect issues with the deployed change as soon as possible.

8. The method of claim 7, wherein deploying the change across the cloud-based system via the phased rollout further comprises deploying the change across remaining subsets of the running service instances in a final rollout phase in response to no detected issues with the deployed change across the representative subset, the remaining subsets of the running service instances including the running service instances without the representative subset of the running service instances.

9. The method of claim 1, wherein performing the at least one operational decision comprises adjusting alert thresholds to reflect a state and a classification of the running service instances.

10. The method of claim 1, wherein performing the at least one operational decision comprises applying targeted actions to the classified running service instances based on a classification of the classified running service instances.

11. The method of claim 1, wherein the collected metrics comprise time-series data.

12. A computer program product comprising one or more computer readable storage media having program instructions collectively stored on the one or more computer readable storage media, the program instructions executable to:
collect a plurality of metrics as time-series data for running service instances within a system;
classify the running service instances into a color classification using a machine learning algorithm based on the collected plurality of metrics for the running service instances; and
deploy a change across the system via a phased rollout based on a classification of the running service instances.

13. The computer program product of claim 12, wherein the system comprises a cloud-based system.

14. The computer program product of claim 12, wherein the machine learning algorithm comprises a k-means clustering algorithm.

15. The computer program product of claim 12, wherein the machine learning algorithm comprises a dbscan algorithm.

16. The computer program product of claim 12, wherein the machine learning algorithm comprises a spectral clustering algorithm.

17. The computer program product of claim 12, wherein the deploying the change across the system via the phased rollout comprises deploying the change across a representative subset of the running service instances in an initial rollout phase to detect issues with the deployed change as soon as possible.

18. The computer program product of claim 17, wherein the deploying the change across the cloud-based system via the phased rollout further comprises deploying the change across remaining subsets of the running service instances in a final rollout phase in response to no detected issues with the deployed change across the representative subset, the remaining subsets of the running service instances including the running service instances without the representative subset of the running service instances.

19. A system comprising:
a processor set, one or more computer readable storage media, and program instructions collectively stored on the one or more computer readable storage media, the program instructions executable to:
collect a plurality of metrics for running service instances within a cloud-based system;
classify the running service instances into a database classification using a k-means clustering algorithm based on the collected plurality of metrics for the running service instances; and
perform at least one operational decision corresponding to the classified running service instances.

20. The system of claim 19, wherein the plurality of metrics is selected from the group consisting of a network utilization, memory utilization, CPU usage, and network connection count.
